(19) United States
(12) Patent Application Publication
(10) Pub. No.: US 2015/0154700 A1
(43) Pub. Date: Jun. 4, 2015

(54) Method of Tracking and Displaying Stocks Information Utilizing Candlestick Charts

(71) Applicant: Michael Steven Hackett, Toms River, NJ (US)

(72) Inventor: Michael Steven Hackett, Toms River, NJ (US)

(21) Appl. No.: 14/474,701

(22) Filed: Sep. 2, 2014

Related U.S. Application Data
(60) Provisional application No. 61/911,249, filed on Dec. 3, 2013.

(51) Int. Cl. G06Q 40/04; G06F 3/0481; G06F 17/24

(52) U.S. Cl. CPC G06Q 40/04; G06F 3/0481; G06F 17/246

(57) ABSTRACT

A method of tracking and displaying stock information utilizing candlestick is provided as a means of generating graphical representation of stock data that is used to determine patterns to help influence decision making as well as teach a user about stock trends. The method receives a plurality of stock data for a particular stock over the course of a plurality of trading intervals. The method extracts particular pricing information from the plurality of stock data and uses the information to generate a graphical representation of the particular stock for each trading interval of the plurality of trading intervals. The method utilizes a computerized system to carry out certain functional aspects such as communicating with external distribution services, storing large quantities of data, graphically representing said data, analyzing the graphically represented data, and generating notifications based on possible patterns in the represented data.

The current application claims a priority to the U.S. Provisional Patent application Ser. No. 61/911,249 filed on Dec. 3, 2013.

### FIELD OF THE INVENTION

The present invention relates generally to a system and a method relating to stock market trading. More specifically, the present invention is a system and a method for visualizing and comprehending stock market interactions, exchanges, curves, and patterns for learning or trading purposes.

### BACKGROUND OF THE INVENTION

The stock market is a loose network of economic transactions centralized on the acquisition and trading of stocks (shares). The stock of a corporation comprises the capital raised for said corporation via selling of shares. An owner of a share is a shareholder and has claim to a part of the said corporation's assets and earnings. Market participants include mutual funds, banks, insurance companies, hedge funds, public and private corporations, and individual investors. In the early days, stock market trading relied on the physical presence in order to obtain real time information, allowing for calculated judgments and appropriate responses to the market's trends and patterns. The majority of the time individuals relied on accountants and other middle men type institutes for their money investments. While such institutes provided advanced knowledge on stock market trading, they also collected a percentage of the profits. The development of electronic information and communication technology has led to a corresponding rapid increase of direct stock market trading among the general public. This is due to an increase of accessibility to a wide variety of learning tools, real time stock market data, statistical and analytical tools, and instant trading via the internet.

In the modern day, for the serious investor the most essential skill to have is the ability to read, analyze, and interpret candlestick based charts. In the 1700s, Homma, a legendary Japanese rice trader, revolutionized the way stock data is animated by inventing the candlestick technique, resulting in candlestick based stock market charts. Candlestick charts comprise the aggregation of vertical box and whisker points. A candlestick may be characterized by: a rectangular body; a rectangular body with an upper shadow, a line above; a rectangular body with a lower shadow, a line below; or a combination of the three options. The upper shadow indicates the highest price of the stock during the certain increment of time, the lower shadow indicates the lowest price of the stock. The rectangular portion dictates the difference between the opening and closing price of the stock during said time frame. If the closing price is below the opening price, the body is black. If the closing price is higher than the opening price, the body is white. The benefits of using this method is that a plurality of such patterns give earlier and a more reliable reversal signals. Candles can be configured to show a multitude of various time increments, allowing the user to see patterns on macro or micro scale.

While the candlestick method is a powerful tool for stock market trading, it is a complicated and difficult system to learn. It takes time and practice to be able to utilize the charts to their full extent. Classes that offer to teach this system cost thousands of dollars, and learning through a book individually is time consuming and may result in inaccurate results. The most optimal solution is to obtain a general background on candlestick structures and practice on real time data. With a wide variety of candlestick meanings, it is unrealistic to look up each one while trading in real time. The present invention provides a solution that allows the user to learn about and simultaneously utilize the candlestick system in real time. The present invention provides real time candlestick, pattern, and trend identification. This allows the user to learn the candlestick system as they trade in real time. Furthermore, having information on candlestick structure and pattern is a powerful feature for any market trader, beginner or seasoned.

### BRIEF DESCRIPTIONS OF THE DRAWINGS

FIG. 1 is an image displaying the various key elements found in the displayable chart as per the current embodiment of the present invention.

FIG. 2 is a diagram displaying the elements of a graphical representation of the stock data during a trading interval as per the current embodiment of the present invention.

FIG. 3 is an image displaying a possible way to implement a pattern notification system in the current embodiment of the present invention.

FIG. 4 is a flow chart displaying a general process overview describing the main steps utilized in the method as per the current embodiment of the present invention.

FIG. 5 is flow chart displaying the steps involved in generating a stock profile for configuring a stock profile.

FIG. 6 is a flow chart displaying the steps involved in receiving stock data associated with a particular stock.

FIG. 7 is a flow chart displaying the steps involved in recording initial and final stock prices for a particular trading interval and analyzing a plurality of stock data to determine the maximum and minimum values during a particular trading interval

FIG. 8 is a flow chart displaying the steps involved in generating graphical representations of the stock data within an interval display cell.

FIG. 9 is a flow chart displaying additional steps involved in generating graphical representations of the stock data within the interval display cell.

FIG. 10 is a flow chart displaying the steps involved in plotting a plurality of graphical representation of stock data on a displayable chart.

FIG. 11 is a flow chart displaying the steps analyzing the plotted graphical representations for patterns.

FIG. 12 is a flow chart displaying additional step utilized in the analysis of the plurality of graphical representation on the displayable chart.

### DETAIL DESCRIPTIONS OF THE INVENTION

All illustrations of the drawings are for the purpose of describing selected versions of the present invention and are not intended to limit the scope of the present invention.

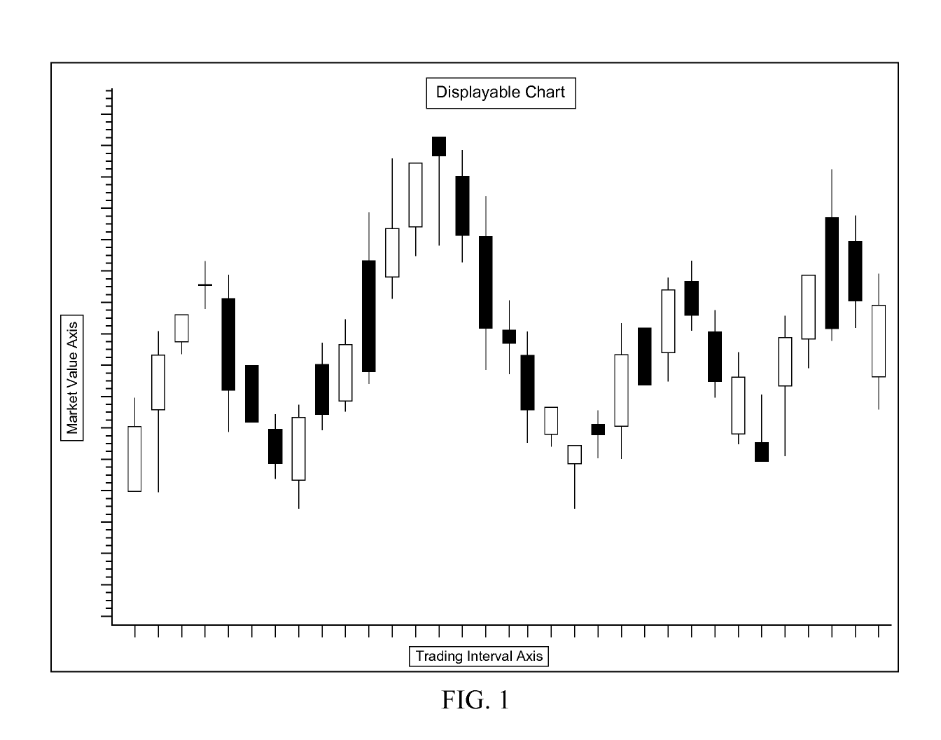

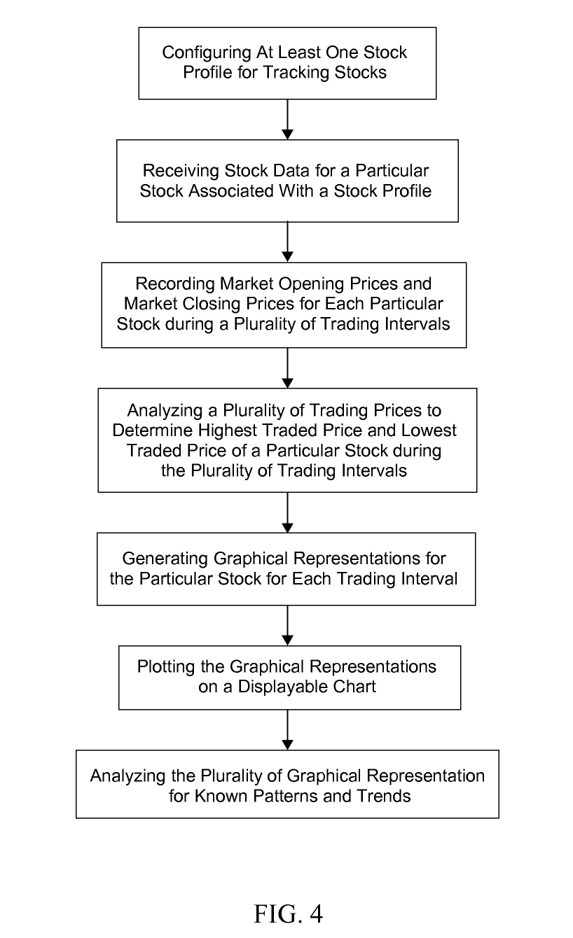

Referencing FIG. 1 and FIG. 4, the present invention is a method of tracking and displaying stocks information utilizing candlestick charts. The method receives a plurality of stock data for a particular stock over the course of a plurality of trading intervals. The method extracts particular pricing information from the plurality of stock data and uses the information to generate a graphical representation of the particular stock for each trading interval of the plurality of trading intervals. The present invention utilizes a computerized system to carry out certain functional aspects of the method. The computerized system comprises a means of communication, data storage components, data processing components, and a user interface. The means of communication is any component or set of components that enables the computerized system to communicate with another system in order to request and receive stock data for a plurality of stocks. The data storage components enable the computerized system to store a large amount of stock data that can be retrieved and analyzed as needed by the data processing components. The data processing components provide the computerized system with a means of analyzing stock data in order to determine patterns and discern key information from the plurality of stock data. The user interface is the component of the computerized system that allows for the exchange of information between a user and the computerized system such as an input means and a display screen. It should be noted that additional components could potentially be incorporated into the computerized system in order to improve the functionality of the present invention.

In an embodiment of the present invention, the computerized system on which the present invention is implemented on may incorporate a touch screen interface. The touch screen interface functions as the user interface through which information is displayed and through which information is entered by a user. Touch screen interfaces enable information to be entered through a virtual keyboard displayed on screen but additionally provide a means of navigating information displayed on screen through gesture inputs. Generally, touch screen interfaces are utilized on mobile devices as a means of savings space. Many mobile devices, such as smart phones and tablets, are provided with a communications module, a processor, and local or remote data storage, as such the present invention would be easily implemented on a mobile device.

Referencing FIG. 4, in the current embodiment of the present invention, the method of displaying and tracking stocks using candle stick chart comprises the steps of configuring at least one stock profile for tracking stocks, receiving stock data for the particular stock, recording market opening prices and the market closing prices for the particular stock, analyzing a plurality of trading prices during a plurality of trading intervals to determine a highest traded prices and a lowest traded prices, generating a plurality of graphical representation for the particular stock, plotting the plurality of graphical representation on a displayable chart, and analyzing the plurality of graphical representation on the displayable chart for known patterns and trends.

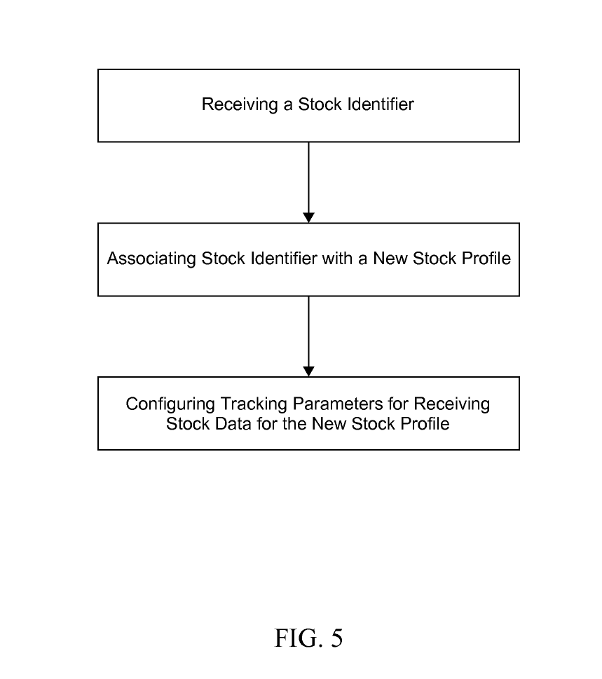

Referencing FIG. 4 and FIG. 5, the step of configuring at least one stock profile enables the method to receive, collect, and analyze a plurality of stock data for a particular stock. The stock profile provides the present invention with a means of associating received and generated information for use in future steps of the method. In the current embodiment of the present invention, the configuration of the at least one stock profile comprises the step of receiving a stock identifier, associating the stock identifier with a new stock profile, and configuring tracking parameters for receiving the stock data for the particular stock. The step of receiving the stock identifier is accomplished through the use of a user interface. The use interface is provided as the means of receiving information that is used to create and configure the stock profile. The stock identifier is the name or market ID for a particular stock. The stock identifier allows the present invention to request stock data for the particular stock associated with the stock identifier through a market information distribution service. It should be noted that the stock identifier is any means of uniquely identifying a particular stock for retrieving stock data. The creation of a new stock profile can occur prior to or following the instance that the stock identifier is received, but the new stock profile is unable to function without being associated with a stock identifier. The step of configuring tracking parameters for receiving stock data for the new stock profile is provided as a means modifying and adjusting how the plurality of stock data is received by the present invention. It should be noted that the configuration of the tracking parameters can dictate the frequency in which the stock data is received as well as any particular relating to how the data is obtained.

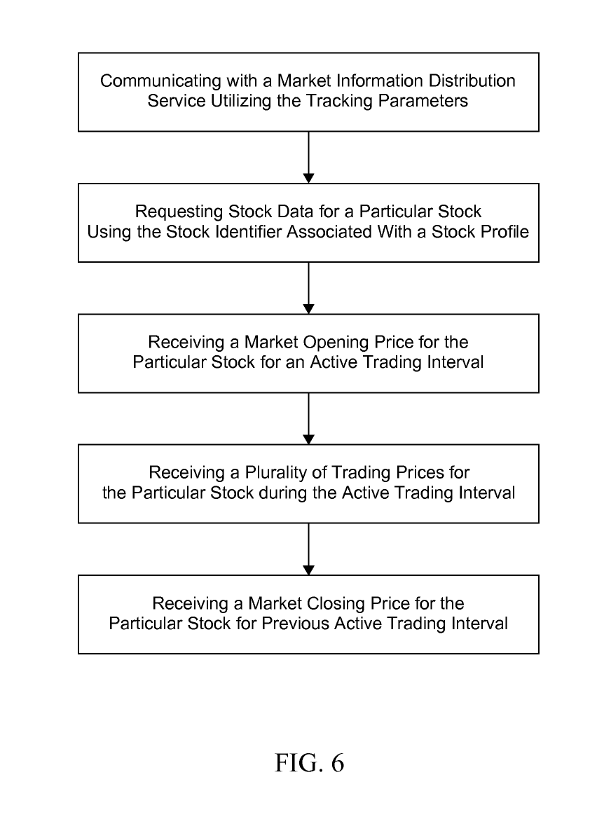

Referencing FIG. 4 and FIG. 6, the step of receiving stock data for the particular stock associated with the stock profile is provided as a data acquisition step necessary to generate the plurality of graphical representations in the displayable chart. Stock data is received for each trading interval of the plurality of trading intervals. In the current embodiment of the present, the step of receiving stock data comprises the steps of communicating with a market information distribution service, requesting stock data for a particular stock using the stock identifier associated with the stock profile, receiving a market opening price for an active trading interval, receiving a plurality of trading prices for the particular stock during the active trading interval, and receiving a market closing prices for the particular stock for a previously active trading interval.

Referencing FIG. 4 and FIG. 6, the market information distribution service is an external service provides stock data for the particular stock profile. It should be noted that the market information distribution service can be accomplished by any communicating entity capable of reporting stock data to the present invention. Communication is established with the market information distribution service utilizing the tracking parameters configured with the stock profile. The tracking parameters can include contact information as well as authenticating information that could potentially be required by market information distribution service. The established communication ensures that the present invention can request and receive stock data for a particular stock during an active trading interval and following the completion of an active trading interval.

Referencing FIG. 4 and FIG. 6, the step of requesting stock data for a particular stock is accomplished following the establishment of communication with the market information distribution service. The present invention requests stock data for a particular stock using the stock identifier associated with the stock profile. The market information distribution service utilizes the stock identifier to retrieve and report the stock data generated by the market for the particular stock. The market information distribution service reports stock data that is generated during each trading interval of the market. Trading intervals are the instance during which a stock is being bought and sold on a market. The stock data reported by the market information distribution service contains key information for a particular stock that occurs during each trading interval. Each trading interval generates a market opening price, a market closing price, and a plurality of trading prices as stock data for a particular stock. At the initiation of a trading interval the market information distribution service reports a market opening price for the particular stock. at the instance when the market opening price is reported the trading interval is deemed as active since a plurality of trading price are generated until the market closes. When the market closes, a market closing price is generated as the final reported value for the particular trading interval. After receiving the market opening price for the particular stock, the present invention receives a plurality of trading prices during the active trading interval. It should be noted that the frequency by which each traded price of the plurality of trading prices is reported can be dependent on a set frequency, where prices are reported at a set interval of time, or dependent on the change in the trading price of the particular stock. The market closing price for a particular stock is reported upon the conclusion of an active trading interval. The market closing price can be received for the previously active interval, since the market closing price is only generated at the conclusion of the previously active trading interval.

Referencing FIG. 6, the step of recoding the market opening price and the market closing price is a required step for generating a graphical representation for a particular stock during a trading interval. in the current embodiment of the present invention, the process of recording the values for the market opening price and the market closing price is accomplished by implementing step that generate a trading interval set for a stock profile associated with a particular stock and a step that stores the prices for later use by the present invention. A trading interval set is generated for each trading interval of the plurality of trading intervals. The trading interval set stores stock data for a particular stock associated with a stock profile. A new trading interval set is generated for each new trading interval resulting in a plurality of trading interval sets being associated with a stock profile. Each trading interval set stores particular information related to a stock's performance during a trading interval such as the market opening price and the market closing price. It should be noted that the generation of a trading interval set for a particular trading interval has to occur in order to store the stock data received during an active trading interval. After a trading interval set is generated for an active trading interval, the market opening price is recorded at the initiation of the active trading interval and the market closing price is recorded at the conclusion of the active trading interval.

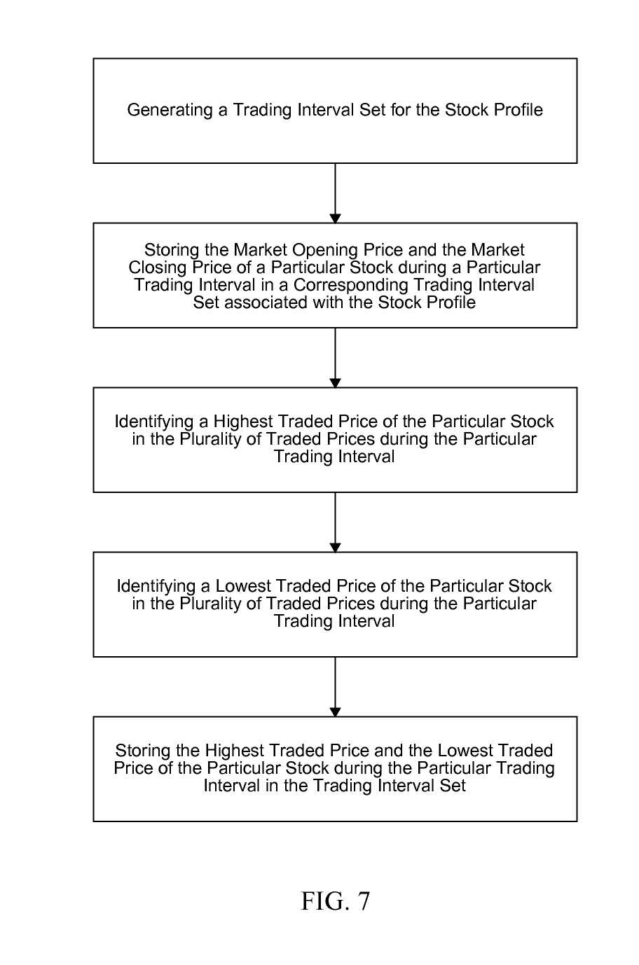

Referencing FIG. 4 and FIG. 7, the step of analyzing the plurality of market trading prices is provided as a data processing step which identifies the highest traded price and the lowest traded price of a particular stock during a particular trading interval. The identified highest traded price and lowest traded price during the particular trading interval are stored in a corresponding trading interval set associated with the stock profile for the particular trading interval. During an active trading interval, the plurality of trading prices for a particular stock are received and analyzed. It should be noted that the analysis can identify the highest traded price and the lowest traded price of a particular stock as the plurality of trading prices are being received, wherein the present invention progressively records the highest trade priced and lowest traded price detected during the trading interval. Alternatively, the present invention can temporarily store every traded price for a particular stock and analyze the plurality of traded prices to detect the highest traded price and the lowest traded price at the conclusion of the particular trading interval. Although the two methods for identifying the highest traded price and the lowest traded price have been described, it should be noted that any means of identifying upper and lower limit values during a particular trading interval could potentially be used. Furthermore, it should be noted that in addition to the value recorded in the trading interval set, the highest traded price and the lowest traded price may contain a time stamp that records the instance each value occurred for later use.

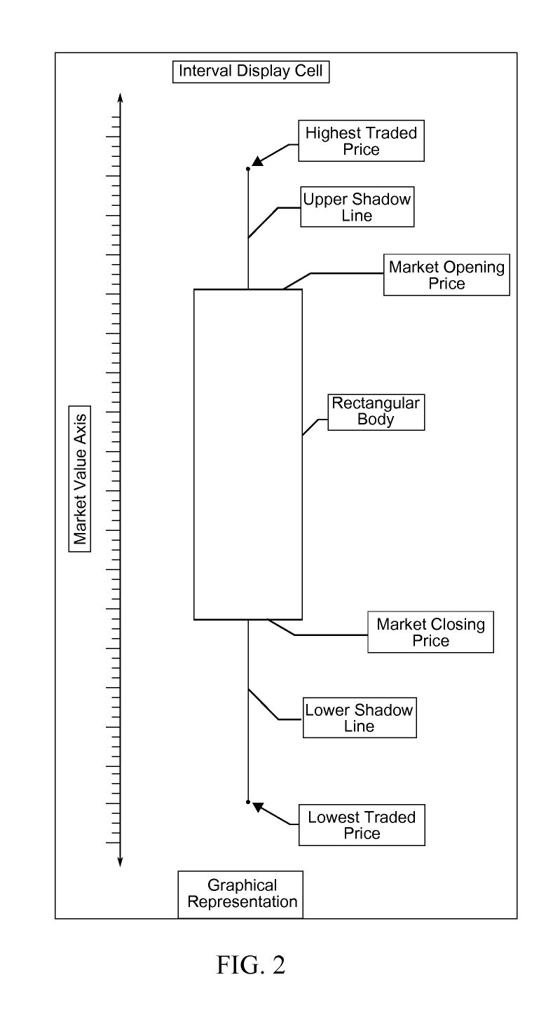

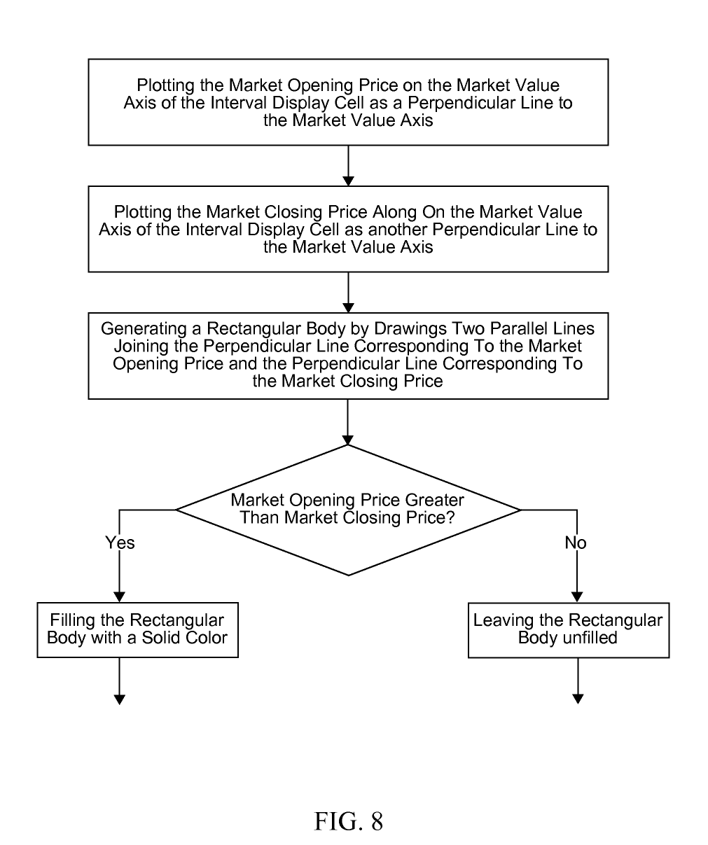

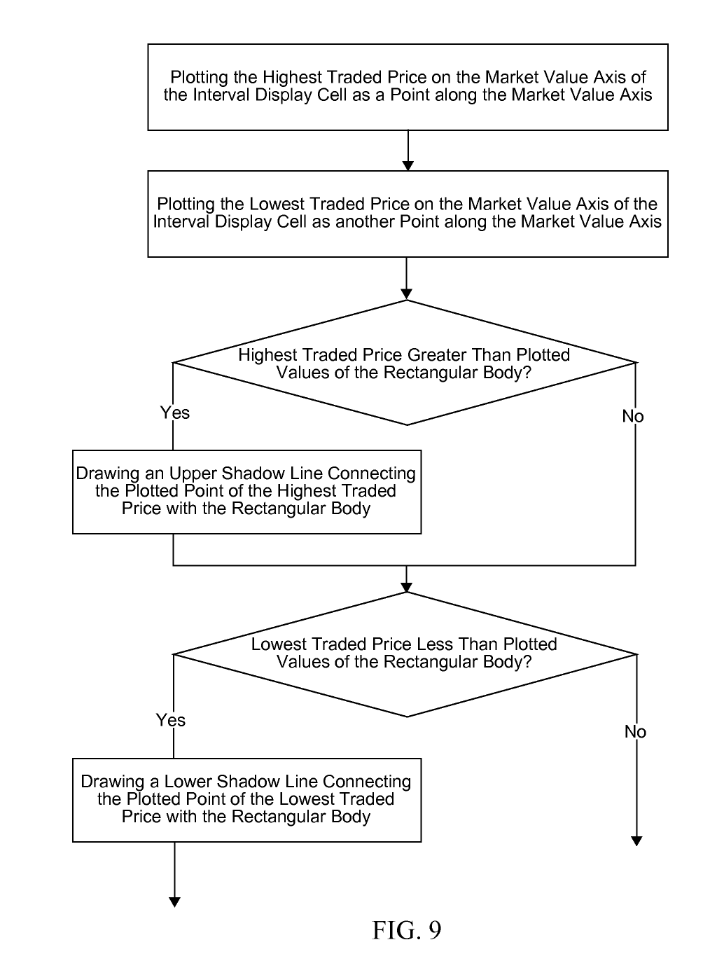

Referencing FIG. 2, FIG. 4, and FIG. 8-9, the step of generating a plurality of graphical representations is provided as a means of creating visual representations of the stock data from the trading interval sets associated with a stock profile. Each graphical representation comprises an interval display cell with a market value axis for plotting the stock data from a trading interval set of a stock profile. The interval display cell is the graphical space on which the values of the trading interval set are visually represented as lines that run perpendicular or parallel with a market value axis. The market value axis is a continuous axis that scales the space within the interval display cell enabling the plotting of the stock data. It should be noted that the market value axis of the interval display cells are uniformly scaled in order to ensure a uniform view when plotted onto the displayable chart. In the current embodiment of the present invention, the step of generating a plurality of graphical representations comprises the steps of plotting the market opening price and the market closing price as perpendicular lines on the market value axis, generating a rectangular body by drawing two parallel lines joining the perpendicular lines corresponding to the market opening price and the market closing price on the market value axis, plotting the highest traded price and the lowest traded price as points on the market value axis, and drawings lines connecting the points corresponding to the highest traded price and the lowest traded price to the rectangular body.

Referencing FIG. 2, FIG. 8, and FIG. 9, the step of plotting the market opening price and the market closing price generates visual markers on the market value axis that represent the values within the interval display cell. The market value axis is a scaled axis measuring the monetary value at which a stock is traded at. The values are continuous but maybe limited to the lowest possible demonization at which the stock can be traded at. Each distinct traded price plotted on the interval display cell will have a distinct positioning within said interval display cell. Since an interval display cell corresponds to a single trading interval set for a particular trading interval, each interval display cell can be viewed as a single column containing the traded values along a measure axis. In the current embodiment of the present invention, the market opening price and the market closing price are plotted on the market value axis as perpendicular lines. The perpendicular lines are relative to the direction in which the values of the market value axis change.

Referencing FIG. 2, FIG. 8, and FIG. 9, the step of generating a rectangular body is provided as a means of visually representing the net change in price for a particular stock during a trading interval. the rectangular body is generated using the perpendicular lines denoting the market opening price and the market closing prices on the market value axis and two lines running parallel to said axis joining the aforementioned perpendicular lines. The two parallel lines span from the perpendicular line of the market opening price and the perpendicular lines of the market closing price and create a bounded rectangular area. The bounded rectangular area is the rectangular body that represents the net change in price of the particular stock over the corresponding trading interval.

Referencing FIG. 2, FIG. 8, and FIG. 9, the step of plotting the highest traded price and the lowest traded price generates visual makers in the interval display cell for the corresponding trading interval. the highest traded price and the lowest traded price upper and lower limits for a particular stock during the course of trading interval that would be greater or less than the market opening price and the market closing price. In the current embodiment of the present invention, the highest traded price and the lowest traded price are visually represented as points on the market value axis. It should be noted that the highest traded price and the lowest traded price may be equal to either the market opening price or the market closing price in which case the plotted values would overlap with the perpendicular line corresponding to either the market opening price or the market closing price. In the aforementioned situation, a point overlapping with either the market opening price or the market closing price would be obscured by the perpendicular line.

Referencing FIG. 2 and FIG. 9, in the current embodiment of the present invention, lines are drawn from the plotted points representing the highest traded price and/or the lowest traded price towards the rectangular body, if the value of the highest traded price is greater and/or if the lowest traded price is lower than the values represented as perpendicular lines for the market opening price or the market closing price. An upper shadow line is drawn from plotted point of the highest traded price down towards the rectangular body, when the value of the highest traded price is greater than both perpendicular lines corresponding to the market opening price and the market closing price. A lower shadow line is drawn from the plotted point of the lowest traded price up towards the rectangular body, when the value of the lowest traded price is less than both perpendicular lines corresponding to the market opening price and the market closing price. The shadow lines are provided as a means of visually representing a disparity between the total changes in the value of a stock during a particular trading interval relative to the net change in the value of the stock over the same particular trading interval.

Referencing FIG. 2 and FIG. 8, in the current embodiment of the present invention, the rectangular body represents the net change in the price of the price of a particular stock. The net change in price for a particular stock over a trading interval can be a positive net change or a negative net change. A positive net change occurs when the market opening price is less than the market closing price. A negative net change occurs when the market opening price is greater than the market closing price. In the current embodiment of the present invention, the rectangular body bounded by the perpendicular lines corresponding to the market opening price and the market closing price is filled in with a solid color signifying a net change for a particular stock over a trading interval, when value the market opening price is greater than the value of the market closing price. It should be noted that the solid color is any color that contrasts with the unfilled rectangular body displaying a positive net change in the value for the trading interval. By filling in the rectangular body, the net change of a stock for a particular trading interval is more visually distinct especially when plotted against a plurality of other graphical representations on a displayable chart.

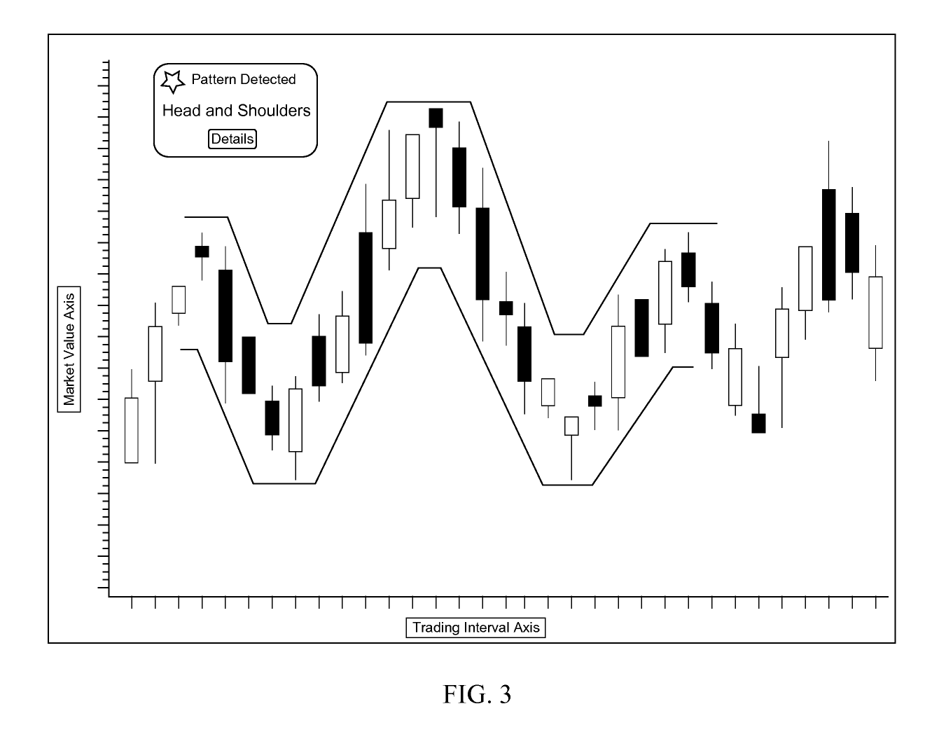

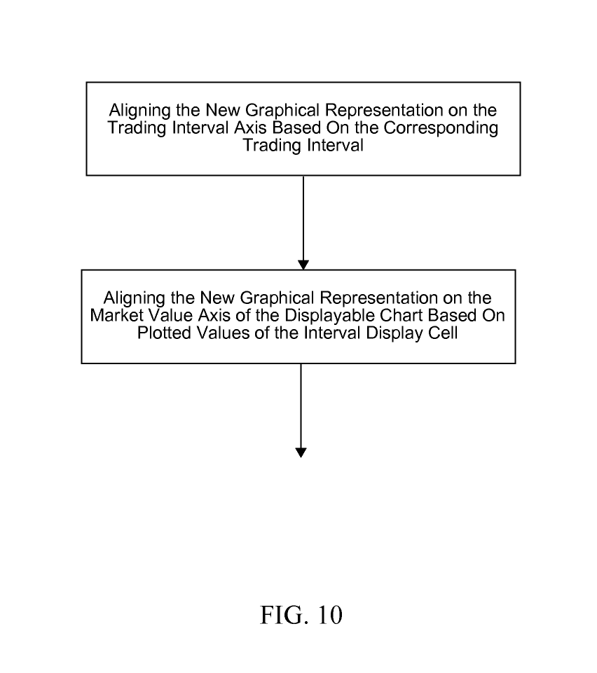

Referencing FIG. 1, FIG. 3, and FIG. 10, a displayable chart is a visual space that is provided by the present invention to display the plurality of graphical representations. Each graphical representation visually displays the performance of a particular stock during a trading interval. The displayable chart presents the graphical representations of plurality of trading intervals in successive order facilitating the visual analysis of a stock's performance relative to the plurality of trading interval. In the current embodiment of the present invention, the displayable chart comprises a trading interval axis and a market value axis. The trading interval axis of the displayable chart corresponds to the plurality of trading intervals arranged in successive order. The market value axis of the displayable chart is scaled proportionally to the market value axis of each interval display cell of a graphical representation. The relationship between the market value axis of the displayable chart and the trading interval axis positions the interval display cells of each graphical representation in a particular order relative to its corresponding trading interval. The dependency of the each graphical representation relative to the order of its trading interval enables allows for tracking the performance of a particular stock.

Referencing FIG. 4 and FIG. 10, in the current embodiment of the present invention the step of plotting a plurality of graphical representations on the displayable chart comprises the steps of aligning a new graphical representation on the trading interval axis according to the positioning of its corresponding trading interval, and aligning the new graphical representation on market value axis of the displayable chart based on plotted values of the graphical representation on interval display cell. The positioning of a new graphical representation on displayable chart occurs following the creation of said graphical representation. Since trading intervals are recorded on the displayable chart successively, a new graphical representation is the newest entry on the trading interval axis. The alignment of new graphical representation on the market value axis of the displayable chart positions the plotted values for the market opening price, the market closing price, the highest traded price, and the lowest traded prices, as well as the visual cue suggesting a negative or positive net change in the price for a particular stock during the trading interval relative to their existing position on the market value axis of the interval display cell. The market value axis of the interval display cell is proportional with the market value axis of the displayable chart permitting an equivalent positioning of the plotted values within the interval display cell on the market value axis of the displayable chart.

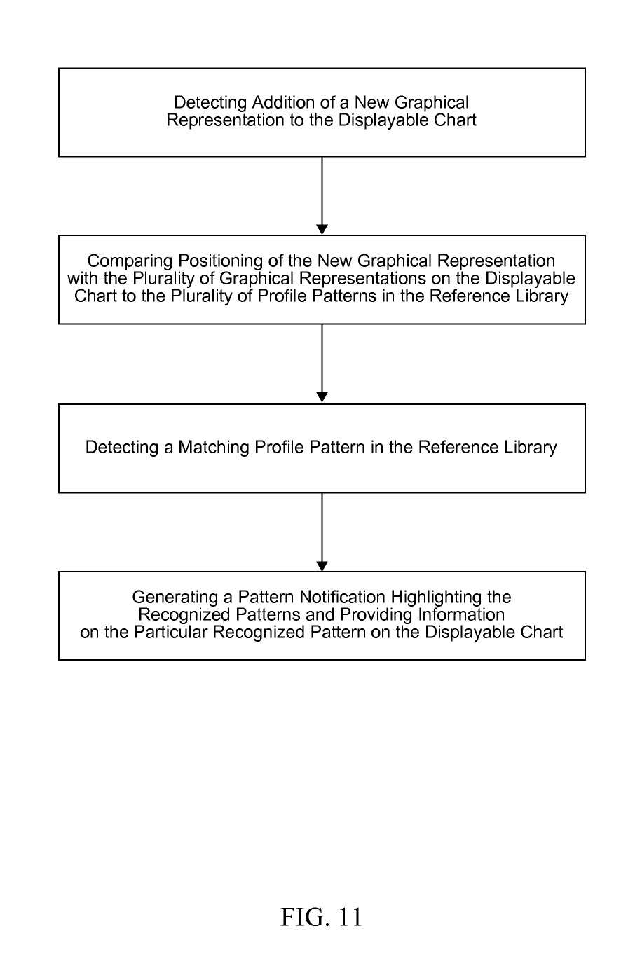

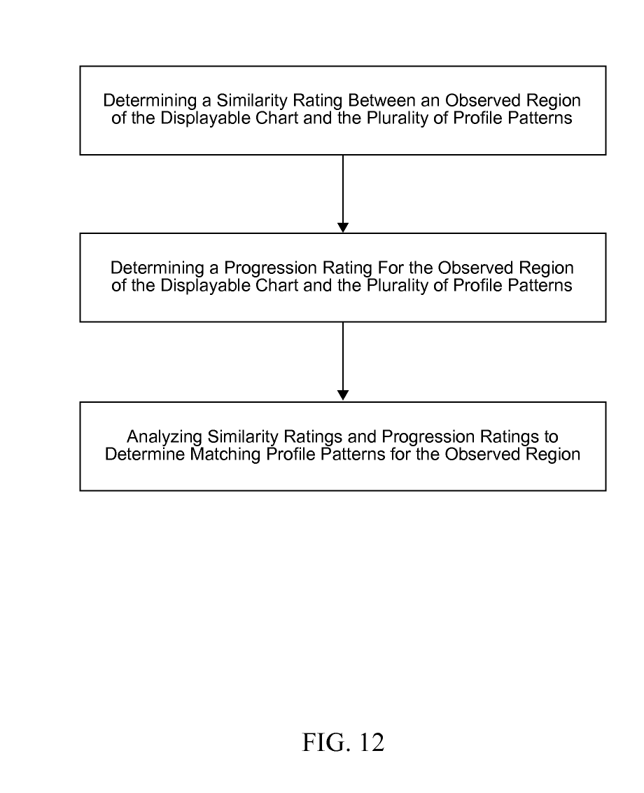

Referencing FIG. 4, FIG. 11, and FIG. 12, the step of analyzing the displayable chart is provided as a means of identifying patterns in the visual data that would allow a user to predict possible future activity of the particular stock. In the current embodiment of the present invention, a reference library is provided as a means of comparing the visual information presented in the displayable chart for the plurality of graphical representations against known visual patterns. The reference library comprises a plurality of profile patterns that are visual patterns in the graphical representation that suggest possible future behaviors for a particular stock. In the current embodiment of the present invention, the analysis of the displayable chart comprises the steps of detecting the addition of a new graphical representation to the displayable chart, and comparing the positioning the positioning of the new graphical representation with the plurality of graphical representations on the displayable chart with the plurality of profile patterns in the reference library. If a matching profile pattern is found in the plurality of profile patterns, a pattern notification is generated highlighting regions of the display chart and providing information regarding the determination of the match.

Referencing FIG. 1, FIG. 4, and FIG. 11, the addition of a new graphical representation on the displayable chart initiates a comparison step between the graphical representations on displayable chart and the plurality of profile patterns within the reference library. It should be noted that a comparison with plurality of profile patterns within the reference library occurs following any modification to the displayable chart as any potential change altering the positioning of a graphical representation would alter previous comparison results. The comparison step looks at identifiable characteristics in the distribution of graphical representations that would indicate a similarity or a match between the information on the displayable chart and a profile pattern from the reference library.

Referencing FIG. 4, FIG. 11, and FIG. 12, in an embodiment of the present invention, the comparison step identifies a region of the displayable chart that contains the new graphical representation positioned near the plurality of graphical representations as the observed region of the displayable chart. The observed region of the displayable chart is the portion of the displayable chart that is analyzed to determine a match with a profile pattern. The comparison step further comprises the steps of determining a similarity rating for the observed region, determining a progression rating for the observed region, and analyzing similarity ratings, progression ratings, and minimum threshold value for each to determine a matching profile pattern.

Referencing FIG. 4, FIG. 11, and FIG. 12, a match between the observed regions of the displayable chart and a profile patterns is determined using similarity ratings and progression ratings between the observed region and each profile pattern of the plurality of profile patterns. A similarity rating is a score that quantifies how closely the observed region resembles a profile pattern. A progression rating is a score that quantifies the likelihood that the observed region will increase in similarity with a profile pattern over subsequent trading intervals. Both scores, the similarity rating and the progression rating, have a minimum threshold value, where a score lower than a certain value would be deemed insignificant and not factored into that analysis step for determining a matching profile pattern. Following the determination of a similarity rating and progression rating for each profile pattern, an analysis step is performed which determines the best matching profile pattern based on either the best score for either the similarity rating or the progression rating. It should be noted that the similarity rating and the progression rating carry equal weight and that in the event of a matching score between a similarity rating of a profile pattern and the progression rating of another profile pattern, both profile patterns would be determined to be a match. Alternatively, if the similarity rating and the progression rating of a profile pattern have the same score, the method would understand that the similarity rating take precedent over the progression rating.

Referencing FIG. 3, FIG. 11, and FIG. 12, the step of generating a pattern notification identifies the area of the displayable chart that was used to determine a matching profile pattern as well as providing information regarding the matched profile pattern. A matched profile pattern gives insight into the expected behavior of a particular stock based on the analysis of its graphical representations. When a matching profile pattern is determined, the system generated identifying markers on the displayable chart that corresponds to identifiable characteristics aided in making the determination. In addition to adding identifying markers, information is provided regarding the particular matched profile pattern that teaches a user about the observed pattern while allowing to use the information to make educated decisions regarding interactions with the particular stock.

Referencing FIG. 3, in an embodiment of the present invention, the pattern notification alert displayed on the displayable chart for matching a profile pattern based on a progression rating would track the progression over the following trading intervals in order to notify a user if the progression resulted in an increased similarity rating with the same profile pattern or whether the progression rating decreased over time. The tracking of a progression rating would be provided as a teaching tool to help users learn alternative outcomes in the progression of a particular stock.

Referencing FIG. 3, in an embodiment of the present invention, the plurality of profile patterns are based on known trends exhibited by stock when graphically represented in a candlestick chart. In an exemplary embodiment of the present invention, some of the known patterns provided as profile patterns include, but are not limited to, head and shoulder, cup and handle, bear flag, and bull flag. Furthermore, some of the other patterns that could be provided as a profile pattern include falling wedge, rising wedge, pennant pattern, double bottom, double top, triple bottoms, triple top, trend line breaks, multiple tops, gaps formation, island formations, abandoned baby, ascending triangle, descending triangle, symmetrical triangle, and channel formation.

Referencing FIG. 3, a head and shoulders pattern displays the formation of three localized data peaks in the displayable chart. The localized data peaks comprise a first peak, a larger second peak, and a third peak similar in amplitude and width to the first peak. The first and third peak are interpreted as the left shoulder and right shoulder, respectively, while the second peak is understood as the head. An imaginary neckline is drawn across the bottoms of the left should, the head, and the right shoulder. The imaginary neckline is key to identifying a head and shoulders pattern as it represents a support level in the price fluctuation of the particular stock. The confirmation of a head and shoulder pattern can be used to measure the minimum probable extent of a subsequent move from the neckline representing the declining price of the particular stock. It should be noted that the head and shoulder patterns are not perfectly shaped and can be formed slightly tilted upward or downward and can vary in the size and width of the left and right shoulder. Furthermore it should be noted that the head and shoulder patterns may be configured to be in a top and bottom configuration. In the exemplary embodiment of the invention, the detection of the three peaks with relation to a neckline would be used as a means of detecting a head and shoulder pattern.

A cup and handle pattern displays the formation of two peaks with relatively equal heights with a long semicircular looking valley positioned between them. The semicircular looking valley is interpreted as the ‘cup’ portion. Positioned adjacent to the second peak is a noticeably smaller valley which is interpreted as the ‘handle’ portion. The ‘handle’ portion completes the pattern and is used to indicate a generally upward trend in the price of the particular stock. In an exemplary embodiment of the invention, the detection of a semicircular looking valley positioned adjacent to a smaller valley would be used as the means of detecting the formation of a cup and handle pattern.

Bear flag and Bull flag patterns display the formation of a ‘pole’ and a ‘flag’ in the displayable chart. The ‘pole’ corresponds to a relatively rapid change in the price of a particular stock represented by the formation of a steep rising or falling peak. Adjacent to the ‘pole’ is a ‘flag’ portion that is a section of data with minor price fluctuations from one trading interval to another but with a general trending direction. Bear flags and bull flags are differentiated by the positioning of the ‘pole’ vs the ‘flag’ portion on the displayable chart. Bear flags represent a situation where sellers strongly dominate the price of a particular stock during the ‘pole’ portion resulting in a sudden drop in the overall price of a stock. The price of the stock is stabilized during the ‘flag’ portion wherein price fluctuation over a course of several trading intervals remain within two parallel bounding lines suggesting a general trend in the movement of the price. Bull flags represent a situation where buyers strongly dominate the price of a particular stock during the ‘pole’ portion resulting in sudden increase in the price of a stock. The price of the stock is stabilized during the ‘flag’ portion, fluctuating over the course of several trading intervals between two parallel bounding lines that suggest a general trend in the movement of the price for the particular stock. In an exemplary embodiment of the present invention, the directionality of a sudden change in the price of a stock near a section with relatively low fluctuation in the price of the particular stock over several trading intervals would be used as the means of detecting a flag formation.

In an embodiment of the present invention, the detection of a profile pattern could be determined based on the positioning and appearance of a graphical representation relative to the plurality of graphical representations. The appearance of the graphical representation referrers to its positioning on the market value axis of the displayable chart while its appearance refers to length of the rectangular body, and whether the rectangular body is filled in with a solid color. Additionally, the lengths of the upper shadow line and the lower shadow lines relative to the size and color of the rectangular body would be considered in a determination of a profile pattern.

In an embodiment of the present invention, the reference library comprises a plurality of profile patterns that track short term changes that can be used to better predict the outcome of long term patterns. the plurality of profile patterns focusing on short term changes look at the identifiable characteristic seen in the plurality of graphical representations with regards to the size of a rectangular body and the length of an upper and lower shadow lines relative to their positioning to another graphical representation. Some of the identifiable characteristics include long and short rectangular bodies, marubozu, long and short shadow lines, spinning tops, and doji's.

Long and short rectangular bodies represent large net changes in the in the price of the stock during a trading interval. depending on the shading of the rectangular body, shaded or unshaded, the change in the stock price can be interpreted as being indicative of a strong selling pressure, shaded, or a strong buying pressure, unshaded, during the particular trading interval. Marubozus are graphic representations that lack both an upper and lower shadow and thus the highest traded price and the lowest traded price are equivalent to the either the market opening price or the market traded price. A shaded marubozu indicates a situation where the sellers controlled the price of the particular stock during the particular trading interval. An unshaded marubozo indicates a situation where the buyers controlled the price of the particular stock during a particular trading interval. Long shadow lines indicate trading intervals were either buyers or sellers initially dominated the value of a particular stock that was eventually dominated by the opposing party in the latter portion of the trading interval. Spinning tops are display a short rectangular body but long upper and lower shadow lines. Spinning tops indicate a trading interval where neither the buyers nor the sellers have an advantage in controlling the price of the particular stock. Spinning tops indicate a pattern profile is changing from its current trend. Doji's indicate situation where the market opening price and the market closing price are near equal. Doji's indicate an indecisive situation between buyers and sellers as neither is able to dominate or control the price of the particular stock. Doji's are most useful when positioned next to another identifiable characteristic as they can be viewed as the beginning or end of a particular pattern.

The invention is a system and a method for obtaining, processing, formatting, analyzing, and displaying stock market data. The invention seeks to provide a means for displaying stock market information in such a matter so as to aid the user in its interpretation in order to result in the most beneficial financial decisions. In an embodiment, the invention comprises a system and a method. The system performs the actions that are defined by the method of the invention and contains all necessary data and program files for use during operation of the invention. The invention is not limited with respect to the specific components forming the system.

In an embodiment of the invention, the system comprises a database, a server, and a software. The database is used to store all physical memory required for the operation of the system of the invention. As such, all data and program files that are used during the method of the invention are stored and accessible through the database. For example, prior stock market data, pattern determining algorithms, and candlestick information may be stored on the database. It is important to note that the system may function without constant Internet connection, the user may access and analyze previously saved stock data for practice and learning purposes, although in order to utilize the invention during real time stock trading, an Internet connection must be maintained. As such, the server of the system maintains the Internet connection during use of the invention for real time stock market trading.

The software is installed onto the database and is accessible by a user anytime, internet connection present or not. The invention may be installed onto a plurality of devices including, but not limited to desktop computers, hand held smartphones, laptops, and tablets. The software provides an intuitive, convenient, and accessible user interface through which user may interact with the system of the invention. The software is capable and responsible for accessing, analyzing, manipulating, transforming, defining, and displaying real time stock market information.

The method comprises the procedure and steps taken by the system during the course of operation of the invention. The steps as defined in an embodiment of the invention may be rearranged and/or modified in order to accommodate varying applications of the invention.

The initial step of the method relates generally to accessing stock market trading information. Ideally, the invention maintains constant connection to the stock market via the Internet, allowing stock market data to be analyzed and manipulated by the software. It is important to note that prior stored stock market information may also be used by the invention in the case Internet access is not available or the user chooses said information for training purposes. In order to form candlestick charts the software must have access to the following information on stocks: opening price, closing price, highest price, lowest price, and time interval. Data accessed for initial step is subject to change in the final embodiment of the invention. This pure data is what is fed into secondary step.

The secondary step takes the information gathered in initial step and utilizes it to create candlestick charts. The highest price dictates the upper shadow of the candlestick, while the lowest price forms the lower shadow. The opening price and closing price structure the rectangular body. If the closing price is higher than the opening price then the body is white. If the closing price is lower than the opening price, then the body is black. The stated colors scheme of the invention in no way limits the embodiment of the invention. The body and shadows may be colorized by a plurality of colors in the final embodiment of the invention. For example, red could symbolize a decrease in price, while green an increase. Based on the time increment specified by the user, the invention creates a chart with candlestick points reflecting the time increments and the stock market data.

The tertiary step takes the resultant charts from secondary step and analyzes them for different patterns and trends, defined and predetermined by the programmer. In its simplest form, the invention identifies and displays the different types of candlesticks present in the chart in accordance to traditional Japanese candlestick charting techniques. For example, if the difference between the opening and closing prices is negligible and the lower shadow is longer than the upper shadow, the invention would mark it as a Doji star. In an embodiment, the invention also analyzes the chart for possible patterns and trends. Patterns and trends of each candlestick and between a plurality of candlestick formations, such as a cup and handle pattern. Patterns include, but are not limited to: cup and handle, double top and double bottom, head and shoulders, triangles, gaps, round bottoms, flags and pennants, the wedge, triple tops and bottoms, tweezer tops and bottoms, spinning tops and bottoms, engulfing bullish, piercing line, bullish counterattack, bullish harami, bullish harami cross, morning star, morning doji star, bullish abandoned baby, hammer, inverted hammer, tweezer bottoms, fry pan bottom, three river bottom, three white soldiers, engulfing bearish, dark cloud cover, bearish counterattack, bearish harami, evening star, evening doji star, bearish abandoned baby, hanging man bearish shooting star, bearish gravestone doji, tweezer tops, three black crows, bearish dumpling top, upside gap two crows, two crows, bullish three-line strike, rising three, mat hold, and other informative pattern like behaviors.

The quaternary step arranges and displays the candlesticks on a graph. This step displays the information on a monitor of a computer, smartphone, or a tablet for the user to see, analyze and interact with. In addition to candlestick charts the invention also displays notification icons and other comments on the graph referring to patterns and trends that show potential financial importance. The user may either select on a portion of the chart to be analyzed in more detail, or the user may select a comment or notification to explore its meaning further. In one embodiment of the invention, both options may be pursued simultaneously. Comments and notifications can be displayed and selected by the user in which case a full explanation of the comment is displayed in the comment/suggestion section. An explanation might include, but is not limited to, the definition of the pattern, it's name, the pros and cons of said pattern, and suggested action. In another embodiment of the invention, a new window may open with details and more information on the comment/notification. The user can examine portions of the graph as needed by selecting a region of interest. When a portion of the graph is selected, the software provides the user with information on the segment selected. The density of candlestick in the detailed view is subject to change. Information includes, but is not limited to, types of candlesticks present, their names, defining features, pros and cons, other examples of said candlesticks, types of patterns present, and suggested action. In one embodiment of the invention, the user may hover over a portion of the chart and a detailed view is displayed on the side. In this detailed view each candlestick is defined and more information is provided specific to each one in the plurality of windows above. The number of windows and candlesticks may change in the final embodiment of the invention. Furthermore, information displayed is subject to change in the final embodiment of the invention.

Although the invention has been explained in relation to its preferred embodiment, it is to be understood that many other possible modifications and variations can be made without departing from the spirit and scope of the invention as hereinafter claimed.

What is claimed is:

1. A method of tracking and displaying stocks information utilizing candlestick charts comprises the steps of:
configuring at least one stock profile for tracking stocks, wherein each stock profile is associated with a particular stock;
receiving stock data for the particular stocks associated with a stock profile, wherein stock data comprises market opening prices, market closing prices, and a plurality of trading prices;
recording the market opening prices and the market closing prices for each particular stock for a plurality of trading intervals;
analyzing the plurality of trading prices during a trading interval to determine highest traded prices and lowest traded prices for each particular stock for the plurality of trading interval;
generating a plurality of graphical representations for each particular stock, wherein each graphical representation corresponds to a trading interval of the plurality of trading intervals;
plotting the plurality of graphical representations of a particular stock in a displayable chart; and
analyzing the plurality of graphical representation on displayable chart for known patterns and trends.

2. The step of configuring at least on stock profile as claimed in claim 1 comprises the steps of:
receiving a stock identifier, wherein the stock identifier is specific to a particular stock;
associating the stock identifier with a new stock profile; and
configuring tracking parameters for receiving stock data for the new stock profile.

3. The step of receiving stock data as claimed in claim 1 comprises the steps of:
providing a stock profile associated with a stock identifier and configured with tracking parameters;
communicating with a market information distribution service utilizing the tracking parameters, wherein the market information distribution service is an external service that provides stock data;
requesting stock data for a particular stock using the stock identifier associated with a stock profile;
receiving a market opening price for the particular stock for an active trading interval;
receiving a plurality of trading prices for the particular stock during the active trading interval; and
receiving a market closing price for the particular stock for previous active trading interval.

4. The step of recording the market opening prices and the market closing prices as claimed in claim 1 comprises the steps of:
generating a trading interval set for the stock profile, wherein each trading interval set corresponds to a particular trading interval of the plurality of trading intervals; and
storing the market opening price and the market closing price of a particular stock during a particular trading interval in a corresponding trading interval set associated with the stock profile.

5. The step of analyzing the plurality of trading prices as claimed in claim 1 comprises the steps of:
providing a trading interval set for the stock profile associated with a particular stock, wherein the trading interval set is for a particular trading interval of the plurality of trading intervals;
identifying a highest traded price of the particular stock in the plurality of traded prices during the particular trading interval;
identifying a lowest traded price of the particular stock in the plurality of traded prices during the particular trading interval; and
storing the highest traded price and the lowest traded price of the particular stock during the particular trading interval in the trading interval set.

6. The step of generating a plurality of graphical representations as claimed in claim 1 comprises the steps of:
providing a particular interval set comprising a market opening price, a highest traded price, a lowest traded price, and a market closing price for a particular trading interval;
providing an interval display cell comprising a market value axis for plotting prices values of a particular interval set, wherein an interval display cell is specific to a particular trading interval and used to plot prices of a particular interval set;
plotting the market opening price on the market value axis of the interval display cell as a perpendicular line to the market value axis;
plotting the market closing price along on the market value axis of the interval display cell as another perpendicular line to the market value axis;
generating a rectangular body by drawings two parallel lines joining the perpendicular line corresponding to the market opening price and the perpendicular line corresponding to the market closing price;
plotting the highest traded price on the market value axis of the interval display cell as a point along the market value axis;
plotting the lowest traded price on the market value axis of the interval display cell as another point along the market value axis; and
filling the rectangular body bounded by the perpendicular lines corresponding to the market opening price, the perpendicular line corresponding to the market closing price, and the two parallel lines joining the perpendicular lines with a solid color,
if the perpendicular line corresponding to the market opening price is positioned above the perpendicular line corresponding to the market closing price along the market value axis.

7. The steps of plotting the highest traded price and the lowest traded price as claimed in claim 6 further comprises the steps of:
drawing an upper shadow line connecting the point corresponding to the highest traded price and the rectangular body,
if the point corresponding to the highest traded price is greater than the values bounding the rectangular body, wherein the values bounding the rectangular body correspond to market opening price and the market closing price; and
drawing a lower shadow line connecting the point corresponding to the lowest traded price and the rectangular body,
if the point corresponding to the lowest traded price is less than the values bounding the rectangular body, wherein the values bounding the rectangular body correspond to market opening price and the market closing price.

8. The step of plotting the plurality of graphical representations as claimed in claim 1 comprises the steps of:
providing a new graphical representation, wherein the new graphical representation comprises a rectangular body, an upper shadow, and a lower shadow plotted on the market value axis of an interval display cell;
providing the displayable chart with a market value axis and a trading interval axis, wherein the market value axis of the displayable chart is proportionally scaled to the market value axis of the interval display cell and the trading interval axis corresponds to the plurality of trading intervals arranged in successive order;
aligning the new graphical representation on the trading interval axis based on the corresponding trading interval of the new graphical representation; and
aligning the new graphical representation on the market value axis of the displayable chart based on plotted values of the interval display cell.

9. The step of analyzing the displayable chart as claimed in claim 1 comprises the steps of:
providing a reference library comprising a plurality of profile patterns;
providing the plurality of graphical representations plotted on the displayable chart;
detecting addition of a new graphical representation to the displayable chart;
comparing the positioning of the new graphical representation with the plurality of graphical representations on the displayable chart to the plurality of profile patterns in the reference library; and
generating a pattern notification highlighting the recognized patterns and providing information on the particular recognized pattern on the displayable chart,
if a match is determined between a profile pattern and the positioning of the new graphical representation with the plurality of graphical representations on the displayable chart.

10. The step of comparing the positioning of the graphical representations to the plurality of profile patterns as claimed in claim 9 further comprises the steps of:
providing the positioning of the new graphical representation with the plurality of graphical representations on the displayable chart as an observed region of the displayable chart;
determining a similarity rating between the observed region of the displayable chart and the plurality of profile patterns within the reference library, wherein the similarity rating quantifies how similar the observed region is to a profile pattern of the plurality of profile patterns;
determining a progression rating for the observed region of the displayable chart and the plurality of profile patterns within the reference library, wherein the progression rating quantifies the likelihood that the observed region of the displayable chart increases in similarity with a profile pattern in subsequent trading intervals; and
analyzing similarity ratings, progression ratings, and minimum threshold value for each, in order to determine a matching profile pattern from the plurality of profile patterns.

11. A method of tracking and displaying stocks information utilizing candlestick charts comprises the steps of:
receiving a stock identifier, wherein the stock identifier is specific to a particular stock;
associating the stock identifier with a new stock profile;
configuring tracking parameters for receiving stock data for the new stock profile;
receiving stock data for the particular stocks associated with a stock profile, wherein stock data comprises market opening prices, market closing prices, and a plurality of trading prices;
generating a trading interval set for the stock profile, wherein each trading interval set corresponds to a particular trading interval of the plurality of trading intervals;
storing the market opening price and the market closing price of a particular stock during a particular trading interval in a corresponding trading interval set associated with the stock profile;
identifying a highest traded price of the particular stock in the plurality of traded prices during the particular trading interval;
identifying a lowest traded price of the particular stock in the plurality of traded prices during the particular trading interval;
storing the highest traded price and the lowest traded price of the particular stock during the particular trading interval in the trading interval set;
analyzing the plurality of trading prices during a trading interval to determine highest traded prices and lowest traded prices for each particular stock for the plurality of trading interval;
generating a plurality of graphical representations for each particular stock, wherein each graphical representation corresponds to a trading interval of the plurality of trading intervals;
plotting the plurality of graphical representations of a particular stock in a displayable chart; and
analyzing the plurality of graphical representation on displayable chart for known patterns and trends.

12. The step of receiving stock data as claimed in claim 11 comprises the steps of:
communicating with a market information distribution service utilizing the tracking parameters, wherein the market information distribution service is an external service that provides stock data;
requesting stock data for a particular stock using the stock identifier associated with a stock profile;
receiving a market opening price for the particular stock for an active trading interval;
receiving a plurality of trading prices for the particular stock during the active trading interval; and
receiving a market closing price for the particular stock for previous active trading interval.

13. The step of generating a plurality of graphical representations as claimed in claim 11 comprises the steps of:
providing a particular interval set comprising a market opening price, a highest traded price, a lowest traded price, and a market closing price for a particular trading interval;
providing an interval display cell comprising a market value axis for plotting prices values of a particular interval set, wherein an interval display cell is specific to a particular trading interval and used to plot prices of a particular interval set;
plotting the market opening price on the market value axis of the interval display cell as a perpendicular line to the market value axis;
plotting the market closing price along on the market value axis of the interval display cell as another perpendicular line to the market value axis;
generating a rectangular body by drawings two parallel lines joining the perpendicular line corresponding to the market opening price and the perpendicular line corresponding to the market closing price;
plotting the highest traded price on the market value axis of the interval display cell as a point along the market value axis;
plotting the lowest traded price on the market value axis of the interval display cell as another point along the market value axis;
drawing an upper shadow line connecting the point corresponding to the highest traded price and the rectangular body,
if the point corresponding to the highest traded price is greater than the values bounding the rectangular body, wherein the values bounding the rectangular body correspond to market opening price and the market closing price;
drawing a lower shadow line connecting the point corresponding to the lowest traded price and the rectangular body,
if the point corresponding to the lowest traded price is less than the values bounding the rectangular body, wherein the values bounding the rectangular body correspond to market opening price and the market closing price; and
filling the rectangular body bounded by the perpendicular lines corresponding to the market opening price, the perpendicular line corresponding to the market closing price, and the two parallel lines joining the perpendicular lines with a solid color,
if the perpendicular line corresponding to the market opening price is positioned above the perpendicular line corresponding to the market closing price along the market value axis.

14. The step of plotting the plurality of graphical representations as claimed in claim 11 comprises the steps of:
providing a new graphical representation, wherein the new graphical representation comprises a rectangular body, an upper shadow, and a lower shadow plotted on the market value axis of an interval display cell;
providing the displayable chart with a market value axis and a trading interval axis, wherein the market value axis of the displayable chart is proportionally scaled to the market value axis of the interval display cell and the trading interval axis corresponds to the plurality of trading intervals arranged in successive order;
aligning the new graphical representation on the trading interval axis based on the corresponding trading interval of the new graphical representation; and
aligning the new graphical representation on the market value axis of the displayable chart based on plotted values of the interval display cell.

15. The step of analyzing the displayable chart as claimed in claim 11 comprises the steps of:
providing a reference library comprising a plurality of profile patterns;
providing the plurality of graphical representations plotted on the displayable chart;
detecting addition of a new graphical representation to the displayable chart;
comparing the positioning of the new graphical representation with the plurality of graphical representations on the displayable chart to the plurality of profile patterns in the reference library; and
generating a pattern notification highlighting the recognized patterns and providing information on the particular recognized pattern on the displayable chart,
if a match is determined between a profile pattern and the positioning of the new graphical representation with the plurality of graphical representations on the displayable chart.

16. The step of comparing the positioning of the graphical representations to the plurality of profile patterns as claimed in claim 15 further comprises the steps of:
providing the positioning of the new graphical representation with the plurality of graphical representations on the displayable chart as an observed region of the displayable chart;
determining a similarity rating between the observed region of the displayable chart and the plurality of profile patterns within the reference library, wherein the similarity rating quantifies how similar the observed region is to a profile pattern of the plurality of profile patterns;
determining a progression rating for the observed region of the displayable chart and the plurality of profile patterns within the reference library, wherein the progression rating quantifies the likelihood that the observed region of the displayable chart increases in similarity with a profile pattern in subsequent trading intervals; and
analyzing similarity ratings, progression ratings, and minimum threshold value for each, in order to determine a matching profile pattern from the plurality of profile patterns.
